(19) United States
(12) Patent Application Publication
(10) Pub. No.: US 2007/0082137 A1
(43) Pub. Date: Apr. 12, 2007

(54) Catalytic coatings, method for forming the same, and their application

(76) Inventors: Sheng-Diann Lin, Tao Yuan (TW); Maksudur Rahman Khan, Tao Yuan (TW); Chia-Shiang Lin, Tao Yuan (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/328,133

(22) Filed: Jan. 10, 2006

Related U.S. Application Data
(60) Provisional application No. 60/724,879, filed on Oct. 11, 2005.

(51) Int. Cl. B05D 3/12; H01M 4/88

(52) U.S. Cl. 427/370; 502/101

(57) ABSTRACT

The present invention discloses a method for forming a catalytic coating. First, at least one alcohol is provided. Then, at least one alcohol and a solvent are mixed to form a middle solution. Next, a heating process is performed to heat the middle solution, and during the heating process, adding a platinum precursor and a protecting agent to the middle solution, so as to form a catalytic coating containing a plurality of platinum nanoparticles with mainly Pt—Pt bond, wherein the protecting agent comprises any one of any combination of the group consisting of: organic acid, polymeric acid, salt of organic acid and salt of polymeric acid. Furthermore, this invention also discloses methods for forming a fuel cell electrode by the mentioned catalytic coating.

### BACKGROUND OF THE INVENTION

1. Field of the Invention

The present invention is generally related to catalytic coatings, and more particularly to catalytic coatings containing platinum nanoparticles with Pt—Pt bond, their forming methods, and their application in fuel cell electrodes and/or membrane electrode assemblies.

2. Description of the Prior Art

Nanoscale metal particles, so-called nano particles are of great interest because of their potential uses for catalysts, adsorbents and sensors. In past decade sol-gel method appears to be an attractive route to prepare metal nanoparticles, because size and shape may be controlled by changing the chemistry of the solution. The production of metal sols by aqueous methanol reduction of metal salts in the presence of steric stabilizers was first reported by Hirai and co-workers. They have studied the mechanism of particle formation in the Rh-polyvinyl alcohol-methanol-water system but also demonstrated similar synthesis of Pt-sols, including the reduction of H₂PtCl₆ by aqueous methanol in the presence of polyvinyl-pyrrolidone (PVP). Teranishi T. et. al. studied Pt colloid formation by the reduction of hexachloroplatinic acid by hydrogen and methanol in presence of sodium polyacrylate (PAA) and PVP. Their study showed that Pt nanoparticles were of controlled size and shape. Chen and Akshi prepared Pt nano particles by ethanol reduction of PtCl₆²⁻ in presence of poly(N-vinylformamide), poly (N-vinylacetamide) and poly(N-isobutaramide).

However, the presence of high molecular weight stabilizing agents may hinder the performance of nanoparticles or cause poisoning reaction. Therefore, these protecting agents have to be removed to prevent unexpected interference reaction for further applications. The removal of protecting agent usually adopts the operation like burn off, pyrolysis, or extraction. Such an operation may consequently cause complication for the nanoparticles such as particle agglomeration. Therefore, new method for forming catalytic coatings containing platinum nanoparticles without removal process or with easy removal process is still needed corresponding to both economic effect and utilization in industry.

### SUMMARY OF THE INVENTION

In accordance with the present invention, new catalytic coatings containing platinum nanoparticles with Pt—Pt bond, their forming methods and their application are provided.

One object of the present invention is to employ organic acid or polymeric acid or salt of organic acid or salt of polymeric acid or their any combination as protecting agents, and the reduction of platinum precursor is performed with the mentioned protecting agent and at least one alcohol. Consequently, the prepared platinum nanoparticles are with mainly Pt—Pt bond, and the diameter of the platinum nanoparticle is less than 5 nm (2 nm to 3 nm is preferred). Moreover, the reduction efficiency and conversion are pretty high comparing to conventional technologies.

Another object of the present invention is to apply catalytic coatings containing platinum nanoparticles for forming catalyst layers in fuel cell electrodes and/or membrane electrode assemblies. Because the provided catalytic coatings will cause no poisoning or hindering effect in fuel cell operation, the catalytic coatings can be used directly without removal process or with easy removal process. Therefore, this present invention does have the economic advantages for industrial applications.

Accordingly, the present invention discloses a method for forming a catalytic coating. First, at least one alcohol is provided. Then, at least one alcohol and a solvent are mixed to form a middle solution. Next, a heating process is performed to heat the middle solution, and during the heating process, adding a platinum precursor and a protecting agent to the middle solution, so as to form a catalytic coating containing a plurality of platinum nanoparticles with mainly Pt—Pt bond, wherein the protecting agent comprises any one of any combination of the group consisting of: organic acid, polymeric acid, salt of organic acid and salt of polymeric acid. Furthermore, this invention also discloses methods for forming a fuel cell electrode by the mentioned catalytic coating.

### DESCRIPTION OF THE PREFERRED EMBODIMENTS

What probed into the invention are catalytic coatings containing platinum nanoparticles with Pt—Pt bond, their forming method, and their application. Detailed descriptions of the production, structure and elements will be provided in the following in order to make the invention thoroughly understood. Obviously, the application of the invention is not confined to specific details familiar to those who are skilled in the art. On the other hand, the common elements and procedures that are known to everyone are not described in details to avoid unnecessary limits of the invention. Some preferred embodiments of the present invention will now be described in greater detail in the following. However, it should be recognized that the present invention can be practiced in a wide range of other embodiments besides those explicitly described, that is, this invention can also be applied extensively to other embodiments, and the scope of the present invention is expressly not limited except as specified in the accompanying claims.

### DEFINITIONS

The term “catalytic coating” herein refers to a solution containing platinum nanoparticles with Pt—Pt bond, wherein the “catalytic coating” can be directly used in applications such as fabricating fuel cell electrodes and/or membrane electrode assemblies.

In a first embodiment of the present invention, a method for forming a catalytic coating is disclosed. First, at least one alcohol is provided, wherein the alcohol is C1 to C4 alcohol, such as: methanol, ethanol, ethylene glycol, iso-propanol and 1-butanol. Then, at least one alcohol and a solvent (e.g. water) are mixed to form a middle solution. Next, a heating process is performed to heat the middle solution, and during the heating process, adding a platinum precursor and a protecting agent to the middle solution, so as to form a catalytic coating containing a plurality of platinum nanoparticles with mainly Pt—Pt bond, wherein the diameter of the platinum nanoparticle is less than 5 nm (2 nm to 3 nm is preferred), and the protecting agent comprises any one of any combination of the group consisting of: organic acid, polymeric acid, salt of organic acid and salt of polymeric acid. The temperature of the heating process is equal to or higher than 60° C., and more preferred, the heating process is performed to heat the middle solution to reflux. The heating process duration is more than 15 minutes from the platinum precursor and the protecting agent being added. Furthermore, the platinum precursor comprises any one of any combination of the group consisting of: H₂PtCl₆, K₂PtCl₆, PtCl₄, [Pt(NH₃)₄]Cl₂. The organic acid comprises any one of any combination of the group consisting of: oxalic acid, malonic acid, succinic acid, glutaric acid, adipic acid, malic acid, tartaric acid, citric acid, glycolic acid, lactic acid, and ascorbic acid. The polymeric acid comprises sulfonated polymers which can be made in solution form (e.g. H-form Nafion® solution). Preferred types about salt of organic acid and salt of polymeric acid are sodium salts or potassium salt. Moreover, the volume fraction of at least one alcohol is from 2% to 95% of the middle solution, and 4% to 90% is preferred. The molar ratio of the protecting agent to the platinum precursor is larger than 0.3, and 0.5 to 5 is preferred. Additionally, after the heating process, a cooling process can be performed to cool the catalytic coating to a temperature equal to or lower than 35° C., and more preferred, the cooling process is performed when the mixture turned into black color. More precisely, for example, the cooling process is performed when the UV-visible absorbance of PtCl₆²⁻ in the heated mixture disappears. The mentioned catalytic coating can be used for forming catalyst layers in fuel cell electrodes and/or membrane electrode assemblies.

In a second embodiment of the present invention, a method for forming a catalytic coating is disclosed. First, at least one alcohol is provided, wherein the alcohol is C1 to C4 alcohol, such as: methanol, ethanol, ethylene glycol, iso-propanol and 1-butanol. Then, at least one alcohol, a solvent (e.g. water) and a protecting agent are mixed to form a middle solution, wherein the protecting agent comprises any one of any combination of the group consisting of: organic acid, polymeric acid, salt of organic acid and salt of polymeric acid. The organic acid comprises any one of any combination of the group consisting of: oxalic acid, malonic acid, succinic acid, glutaric acid, adipic acid, malic acid, tartaric acid, citric acid, glycolic acid, lactic acid, and ascorbic acid. The polymeric acid comprises sulfonated polymers which can be made in solution form (e.g. H-form Nafion® solution). Preferred types about salt of organic acid and salt of polymeric acid are sodium salts or potassium salt. Next, a heating process is performed to heat the middle solution, and during the heating process, adding a platinum precursor to the middle solution, so as to form a catalytic coating containing a plurality of platinum nanoparticles with mainly Pt—Pt bond, wherein the diameter of the platinum nanoparticle is less than 5 nm (2 nm to 3 nm is preferred). The temperature of the heating process is equal to or higher than 60° C., and more preferred, the heating process is performed to heat the middle solution to reflux. The heating process duration is more than 15 minutes from the platinum precursor being added. Furthermore, the platinum precursor comprises any one of any combination of the group consisting of: H₂PtCl₆, K₂PtCl₆, PtCl₄, [Pt(NH₃)₄]Cl₂. Moreover, the volume fraction of at least one alcohol is from 2% to 95% of the middle solution, and 4% to 90% is preferred. The molar ratio of the platinum precursor and to the platinum precursor is larger than 0.3, and 0.5 to 5 is preferred. Additionally, after the heating process, a cooling process can be performed to cool the catalytic coating to a temperature equal to or lower than 35° C., and more preferred, the cooling process is performed when the mixture turned into black color. More precisely, for example, the cooling process is performed when the UV-visible absorbance of PtCl₆²⁻ in the heated mixture disappears. The mentioned catalytic coating can be used for forming catalyst layers in fuel cell electrodes and/or membrane electrode assemblies.

In a third embodiment of the present invention, a method for forming a fuel cell electrode is disclosed. First, providing a mixture comprising the catalytic coating as described in the first embodiment or the second embodiment, wherein the mixture can further comprises carbon powders and/or Nafion solution (e.g. H-form Nafion® solution or Na-form Nafion® solution). Next, a depositing process is performed to deposit the mixture onto a polymer electrolyte membrane (e.g. Nafion membrane), wherein the depositing process is selected from the group consisting of: filtration, brushing, spraying and coating. Then, a solidifying process is performed to solidify the mixture on the polymer electrolyte membrane, so as to form a catalyst layer. Finally, a hot pressing process is performed to combine the catalyst layer with a gas diffusion layer (water repellent treated gas diffusion layer is preferred), so that the fuel cell electrode is fabricated. The temperature of the hot pressing process is higher than 70° C., and 80° C. to 120° C. is more preferred. The pressure of the hot pressing process is larger than 5 kg/cm², and 5 kg/cm² to 40 kg/cm² is preferred. Additionally, the gas diffusion layer is selected from the group consisting of: carbon paper and carbon cloth.

In this embodiment, the mentioned solidifying process comprises a first drying process to dry the mixture on the polymer electrolyte membrane, wherein the temperature of the first drying process is lower than 90° C., preferred lower than 80° C. The solidifying process can further comprise a cleaning process after the first drying process, comprising: performing a washing process by a cleaning agent (e.g. water) to remove the alcohol and the protecting agent from the catalyst layer, wherein the temperature of the washing process is less than 60° C., and the washing process duration is less than 30 minutes (15 minutes is preferred); and performing a second drying process for removing the cleaning agent from the catalyst layer.

In a fourth embodiment of the present invention, a method for forming a fuel cell electrode is disclosed. First, providing a mixture comprising the catalytic coating as described in the first embodiment or the second embodiment, wherein the mixture can further comprises carbon powders and/or Nafion solution (e.g. H-form Nafion® solution or Na-form Nafion® solution). Next, a depositing process is performed to deposit the mixture onto a gas diffusion layer (water repellent treated gas diffusion layer is preferred), wherein the depositing process is selected from the group consisting of: filtration, brushing, spraying and coating. The gas diffusion layer is selected from the group consisting of: carbon paper and carbon cloth. Then, a solidifying process is performed to solidify the mixture on the gas diffusion layer, so as to form a catalyst layer. Finally, a hot pressing process is performed to combine the catalyst layer with a polymer electrolyte membrane (e.g. Nafion membrane), so that the fuel cell electrode is fabricated. The temperature of the hot pressing process is higher than 70° C., and 80° C. to 120° C. is more preferred. The pressure of the hot pressing process is larger than 5 kg/cm², and 5 kg/cm² to 40 kg/cm² is preferred.

In this embodiment, the mentioned solidifying process comprises a first drying process to dry the mixture on the gas diffusion layer, wherein the temperature of the first drying process is lower than 90° C., preferred lower than 80° C. The solidifying process can further comprise a cleaning process after the first drying process, comprising: performing a washing process by a cleaning agent (e.g. water) to remove the alcohol and the protecting agent from the catalyst layer, wherein the temperature of the washing process is less than 60° C., and the washing process duration is less than 30 minutes (15 minutes is preferred); and performing a second drying process for removing the cleaning agent from the catalyst layer.

In the above preferred embodiments, the present invention employ organic acid or polymeric acid or their salts as protecting agents, and the reduction of platinum precursor is performed with the mentioned protecting agent and at least one alcohol. Consequently, the prepared platinum nanoparticles are with mainly Pt—Pt bond, and the diameter of the platinum nanoparticle is less than 5 nm (2 nm to 3 nm is preferred). Moreover, the reduction efficiency and conversion are pretty high comparing to conventional technologies. Additionally, catalytic coatings containing platinum nanoparticles are used for forming catalyst layers in fuel cell electrodes and/or membrane electrode assemblies. Because the provided catalytic coatings will cause no poisoning or hindering effect in fuel cell operation, the catalytic coatings can be applied directly without removal process or with easy removal process. Therefore, this present invention does have the economic advantages for industrial applications.

To sum up, the present invention discloses a method for forming a catalytic coating. First, at least one alcohol is provided. Then, at least one alcohol and a solvent are mixed to form a middle solution. Next, a heating process is performed to heat the middle solution, and during the heating process, adding a platinum precursor and a protecting agent to the middle solution, so as to form a catalytic coating containing a plurality of platinum nanoparticles with mainly Pt—Pt bond, wherein the protecting agent comprises any one of any combination the group consisting of: organic acid, polymeric acid, salt of organic acid and salt of polymeric acid. Furthermore, this invention also discloses methods for forming a fuel cell electrode by the mentioned catalytic coating.

Obviously many modifications and variations are possible in light of the above teachings. It is therefore to be understood that within the scope of the appended claims the present invention can be practiced otherwise than as specifically described herein. Although specific embodiments have been illustrated and described herein, it is obvious to those skilled in the art that many modifications of the present invention may be made without departing from what is intended to be limited solely by the appended claims.

What is claimed is:

1. A method for forming a catalytic coating, comprising:
providing at least one alcohol;
mixing at least one said alcohol and a solvent to form a middle solution;
performing a heating process to heat said middle solution; and
adding a platinum precursor and a protecting agent to said middle solution during said heating process, so as to form a catalytic coating containing a plurality of platinum nanoparticles with mainly Pt—Pt bond, wherein said protecting agent comprises any one of any combination of the group consisting of: organic acid, polymeric acid, salt of organic acid and salt of polymeric acid.

2. The method as claimed in claim 1, wherein said alcohol is C1 to C4 alcohol.

3. The method as claimed in claim 1, wherein said solvent comprises water.

4. The method as claimed in claim 1, wherein the temperature of said heating process is equal to or higher than 60° C.

5. The method as claimed in claim 1, wherein said heating process is performed to heat said middle solution to reflux.

6. The method as claimed in claim 1, wherein said heating process duration is more than 15 minutes from said platinum precursor and said protecting agent being added.

7. The method as claimed in claim 1, wherein said platinum precursor comprises any one of any combination of the group consisting of: H₂PtCl₆, K₂PtCl₆, PtCl₄, [Pt(NH₃)₄]Cl₂.

8. The method as claimed in claim 1, wherein said organic acid comprises any one of any combination of the group consisting of: oxalic acid, malonic acid, succinic acid, glutaric acid, adipic acid, malic acid, tartaric acid, citric acid, glycolic acid, lactic acid, and ascorbic acid.

9. The method as claimed in claim 1, wherein said polymeric acid comprises sulfonated polymer in solution form.

10. The method as claimed in claim 9, wherein said polymeric acid is H-form Nafion solution.

11. The method as claimed in claim 1, wherein the volume fraction of at least one said alcohol is from 2% to 95% of said middle solution.

12. The method as claimed in claim 1, wherein the molar ratio of said protecting agent to said platinum precursor is larger than 0.3.

13. The method as claimed in claim 1, further comprising a cooling process to cool said catalytic coating to a temperature equal to or lower than 35° C.

14. The method as claimed in claim 1, wherein said catalytic coating is used for forming catalyst layers in fuel cell electrodes and/or membrane electrode assemblies.

15. The method as claimed in claim 14, when said catalytic coating is used for forming a fuel cell electrode, the method for forming said fuel cell electrode comprising:
providing a mixture comprising said catalytic coating;
performing a depositing process to deposit said mixture onto a polymer electrolyte membrane;
performing a solidifying process to solidify said mixture on said polymer electrolyte membrane, so as to form a catalyst layer; and
performing a hot pressing process to combine said catalyst layer with a gas diffusion layer, so that said fuel cell electrode is fabricated.

16. The method as claimed in claim 15, wherein said mixture further comprises carbon powders.

17. The method as claimed in claim 15, wherein said mixture further comprises Nafion solution.

18. The method as claimed in claim 15, wherein said depositing process is selected from the group consisting of: filtration, brushing, spraying and coating.

19. The method as claimed in claim 15, wherein said polymer electrolyte membrane comprises Nafion membrane.

20. The method as claimed in claim 15, wherein said solidifying process comprises a first drying process to dry said mixture on said polymer electrolyte membrane.

21. The method as claimed in claim 20, wherein the temperature of said first drying process is lower than 90° C.

22. The method as claimed in claim 20, wherein said solidifying process further comprises a cleaning process after said first drying process, and said cleaning process comprises:
performing a washing process by a cleaning agent to remove said alcohol and said protecting agent from said catalyst layer; and
performing a second drying process for removing said cleaning agent from said catalyst layer.

23. The method as claimed in claim 22, wherein the temperature of said washing process is less than 60° C.

24. The method as claimed in claim 22, wherein said washing process duration is less than 30 minutes.

25. The method as claimed in claim 22, wherein said cleaning agent comprises water.

26. The method as claimed in claim 15, wherein the temperature of said hot pressing process is higher than 70° C.

27. The method as claimed in claim 15, wherein the pressure of said hot pressing process is larger than 5 kg/cm².

28. The method as claimed in claim 15, wherein said gas diffusion layer is selected from the group consisting of: carbon paper and carbon cloth.

29. The method as claimed in claim 14, when said catalytic coating is used for forming a fuel cell electrode, the method for forming said fuel cell electrode comprising:
providing a mixture comprising said catalytic coating;
performing a depositing process to deposit said mixture onto a gas diffusion layer;
performing a solidifying process to solidify said mixture on said gas diffusion layer, so as to form a catalyst layer; and
performing a hot pressing process to combine said catalyst layer with a polymer electrolyte membrane, so that said fuel cell electrode is fabricated.

30. A method for forming a catalytic coating, comprising:
providing at least one alcohol;
mixing at least one said alcohol, a solvent and a protecting agent to form a middle solution, wherein said protecting agent comprises any one of any combination of the group consisting of: organic acid, polymeric acid, salt of organic acid and salt of polymeric acid;
performing a heating process to heat said middle solution; and
adding a platinum precursor to said middle solution during said heating process, so as to form a catalytic coating containing platinum nanoparticles with mainly Pt—Pt bond.

31. The method as claimed in claim 30, wherein said catalytic coating is used for forming catalyst layers in fuel cell electrodes and/or membrane electrode assemblies.

32. The method as claimed in claim 31, when said catalytic coating is used for forming a fuel cell electrode, the method for forming said fuel cell electrode comprising:
providing a mixture comprising said catalytic coating;
performing a depositing process to deposit said mixture onto a polymer electrolyte membrane;
performing a solidifying process to solidify said mixture on said polymer electrolyte membrane, so as to form a catalyst layer; and
performing a hot pressing process to combine said catalyst layer with a gas diffusion layer, so that said fuel cell electrode is fabricated.

33. The method as claimed in claim 32, wherein said mixture further comprises carbon powders.

34. The method as claimed in claim 32, wherein said mixture further comprises Nafion solution.

35. The method as claimed in claim 31, when said catalytic coating is used for forming a fuel cell electrode, the method for forming said fuel cell electrode comprising:
providing a mixture comprising said catalytic coating;
performing a depositing process to deposit said mixture onto a gas diffusion layer;
performing a solidifying process to solidify said mixture on said gas diffusion layer, so as to form a catalyst layer; and
performing a hot pressing process to combine said catalyst layer with a polymer electrolyte membrane, so that said fuel cell electrode is fabricated.
